(19) United States
(12) Patent Application Publication
(10) Pub. No.: US 2010/0092147 A1
(43) Pub. Date: Apr. 15, 2010

(54) OPTICAL FIBER CABLE RETENTION DEVICE

(76) Inventors: Christophe Desard, Herbihnac (FR); Tahsin Dilmen, Haan (DE)

Correspondence Address: 3M INNOVATIVE PROPERTIES COMPANY, PO BOX 33427, ST. PAUL, MN, 55133-3427, US

(21) Appl. No.: 12/442,817

(22) PCT Filed: Oct. 15, 2007
(86) PCT No.: PCT/US07/81408

§ 371 Date: Mar. 25, 2009

Related U.S. Application Data
(60) Provisional application No. 60/829,581, filed on Oct. 16, 2006.
(60) Provisional application No. 60/913,846, filed on Apr. 25, 2007.

(51) Int. Cl. G02B 6/00; G02B 6/44

(52) U.S. Cl. 385/135; 385/136

(57) ABSTRACT

An optical fiber cable retention device includes a body having first and second opposing portions and a hinge disposed therebetween to retain an optical fiber cable when the optical fiber cable retention device is placed in a closed position. The first and second body portions are engageable with one another about the hinge. At least one of the first and second body portions includes a flexible wall portion configured to provide a retention force to an outer jacket of the fiber cable. At least one of the first and second body portions includes a strength member retention area having one or more structures configured to engage a strength member of the optical fiber cable. The optical fiber cable retention device also includes a latching mechanism to secure the device in the closed position.

### CROSS REFERENCE TO RELATED APPLICATIONS

This application claims the benefit of U.S. Provisional Patent Application No. 60/829,581, filed Oct. 16, 2006, and U.S. Provisional Patent Application No. 60/913,846, filed Apr. 25, 2007, the disclosures of which are incorporated by reference herein in their entirety.

### THE FIELD OF THE INVENTION

The present invention relates generally to an optical fiber cable retention device for telecommunications.

### BACKGROUND OF THE INVENTION

Telecommunication cables are used for distributing all manner of data across vast networks. A telecommunication cable typically includes a bundle of individual telecommunication lines (either optical fibers or copper wires) that are encased within a protective sheath. As telecommunication cables are routed across data networks, it is necessary to periodically open the cable so that one or more telecommunication lines therein may be spliced, thereby allowing data to be distributed to other cables or “branches” of the telecommunication network. The cable branches may be further distributed until the network reaches individual homes, businesses, offices, premises, and so on.

Distribution or drop boxes often contain cable splices or connectorized terminations. These boxes are often located at a home or at another premises and are kept small in size due to space restrictions. As these boxes include one or more optical fiber cables that enter and leave the box, cable retention at these locations is important. In one conventional method, a cable can be retained with a clip this is tied to the box with a screw or other bolt. In other conventional methods, cable ties and screw downs can be used.

### SUMMARY

In one aspect, an embodiment of the invention described herein provides an optical fiber cable retention device that includes a body having first and second opposing portions and a hinge disposed therebetween to retain an optical fiber cable when the optical fiber cable retention device is placed in a closed position. The first and second body portions are engageable with one another about the hinge. At least one of the first and second body portions includes a flexible wall portion configured to provide a retention force to an outer jacket of the fiber cable. At least one of the first and second body portions includes a strength member retention area having one or more structures configured to engage a strength member of the optical fiber cable. The optical fiber cable retention device also includes a latching mechanism to secure the device in the closed position.

In one aspect, the first and second body portions each include flexible wall portions that include flexible spring arms to provide retention force to different sized and/or different shaped optical fiber cables.

In another aspect, at least one of the surfaces of the flexible wall portion that engages the optical fiber cable includes teeth configured to dig into at least a portion of the outer jacket material of the optical fiber cable being secured.

In another aspect, the first body portion includes a first protrusion and the second body portion contains second and third protrusions, where the first protrusion configured to be engaged between the second and third protrusions when the device is in the closed position.

In an alternative embodiment of the invention described herein, an optical fiber cable retention device includes a body having first and second opposing portions and a hinge disposed therebetween to retain strength members of an optical fiber cable when the optical fiber cable retention device is placed in a closed position. The first and second body portions are engageable with one another about the hinge. At least one of the first and second body portions includes a strength member retention area having one or more structures configured to engage a strength member of the optical fiber cable. The optical fiber cable retention device also includes a base attached to the terminal end of the second body portion. The optical fiber cable retention device may further include a securing device to secure the optical fiber to the retention device.

In an alternative embodiment of the invention described herein, an optical fiber cable retention device includes a body portion having a concave surface and a base attached to the terminal end of the body portion. The base may have an arcuate indentation aligned with the concave surface of the body portion to accommodate an optical fiber cable to be disposed thereon. The body portion includes a strength member retention area having one or more structures configured to engage a strength member of the optical fiber cable when a securing device fastens the optical fiber cable to the retention device.

In another aspect, an embodiment of the invention described herein provides a fiber distribution box disposable at a branch point of an optical fiber network, where the fiber distribution box includes one or more slot structures configured to receive one of the optical fiber cable retention devices described above.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

Embodiments of the invention are better understood with reference to the following drawings. The elements of the drawings are not necessarily to scale relative to each other.

FIG. 1A is a first isometric view of an optical fiber cable retention device in an open position according to an aspect of the invention.

FIG. 1B is a second isometric view of an optical fiber cable retention device in an open position according to an aspect of the invention.

FIGS. 2A-2D are top views of an optical fiber cable retention device used to clamp an optical fiber cable according to an aspect of the invention.

FIG. 3A is a top view of a fiber drop box including a cable retention device secured therein according to an aspect of the invention.

FIG. 3B is an isometric view of a fiber drop box including a series of slots configured to receive a cable retention device according to an aspect of the invention.

FIG. 4 is a schematic view of an optical network.

FIG. 5A is a first isometric view of an optical fiber cable retention device in an open position according to an alternative embodiment of the invention.

FIG. 5B is a second isometric view of an optical fiber cable retention device in an open position according to an alternative embodiment of the invention.

FIGS. 6A-6C are isometric views of an optical fiber cable retention device used to clamp an optical fiber cable according to an alternative embodiment of the invention.

FIG. 7 is a top isometric view of a fiber drop box including a cable retention device secured and a series of slots configured to receive a cable retention device according to an alternative embodiment of the invention.

FIG. 8A is a first isometric view of an optical fiber cable retention device in an open position according to another embodiment of the invention.

FIG. 8B is a second isometric view of an optical fiber cable retention device in an open position according to another embodiment of the invention.

FIGS. 9A-B are isometric views of an optical fiber cable retention device used to clamp an optical fiber cable according to another embodiment of the invention.

FIG. 10 is a first isometric view of an alternative optical fiber cable retention device according to another embodiment of the invention.

FIGS. 11A-B are isometric views of a fiber drop box including a cable retention device secured therein according to an alternative embodiment of the invention.

### DETAILED DESCRIPTION

In the following detailed description of the preferred embodiments, reference is made to the accompanying drawings, which form a part hereof, and in which is shown by way of illustration specific embodiments in which the invention may be practiced. The illustrated embodiments are not intended to be exhaustive of all embodiments according to the invention. It is to be understood that other embodiments may be utilized and structural or logical changes may be made without departing from the scope of the present invention. The following detailed description, therefore, is not to be taken in a limiting sense.

The present invention is directed to an optical fiber cable retention device for telecommunications. The optical fiber cable retention device can be used as a small, simple, one-piece securing mechanism that can be used to reduce axial strain of one or more different sized or shaped (i.e. flat cable, round cable, etc.) optical fiber cables entering or exiting a distribution box. In addition, the optical fiber cable retention device may be used in conjunction with cables having either aramid or metallic strength members.

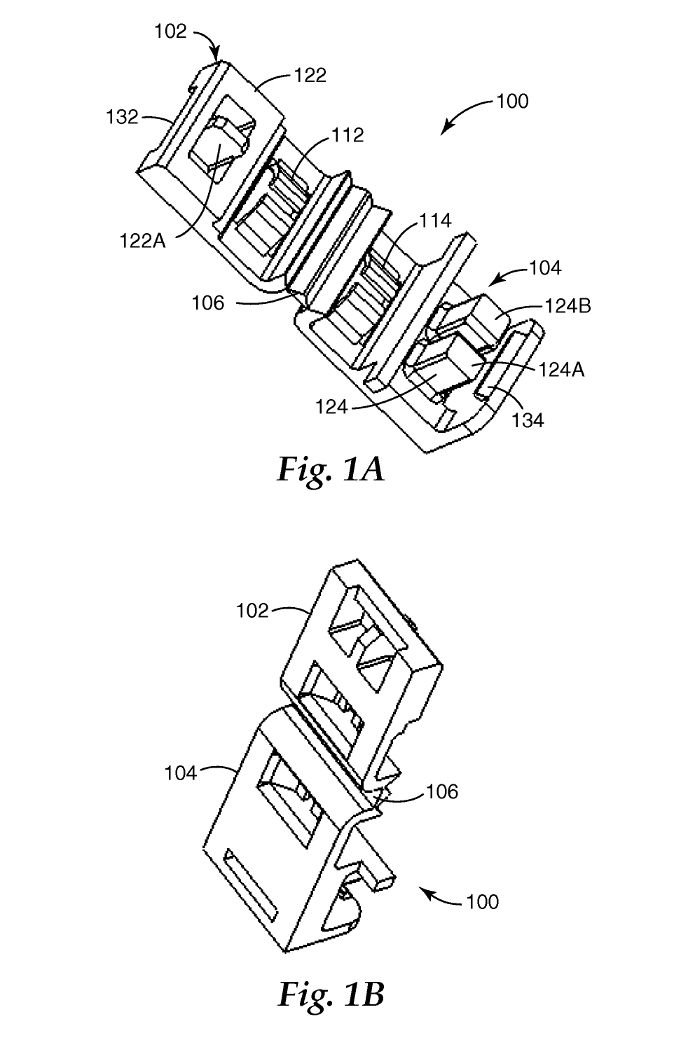

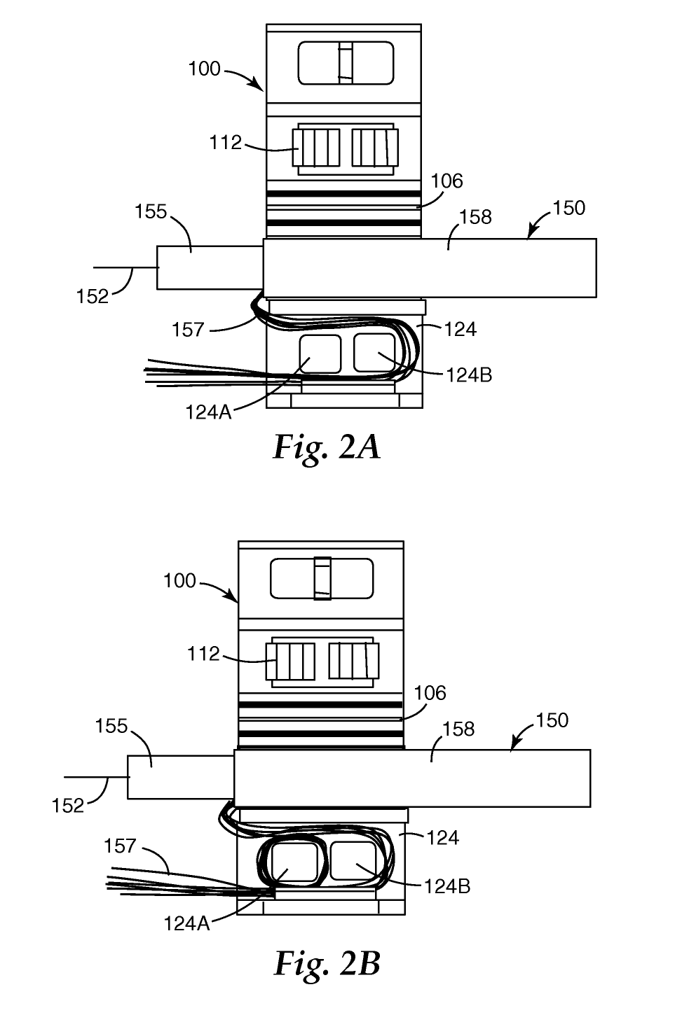

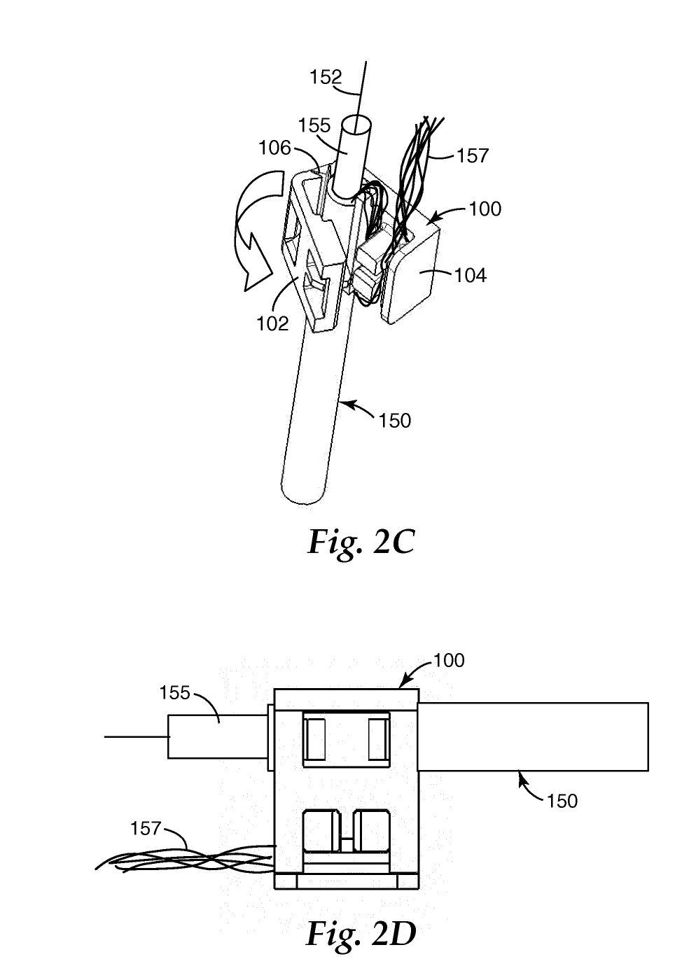

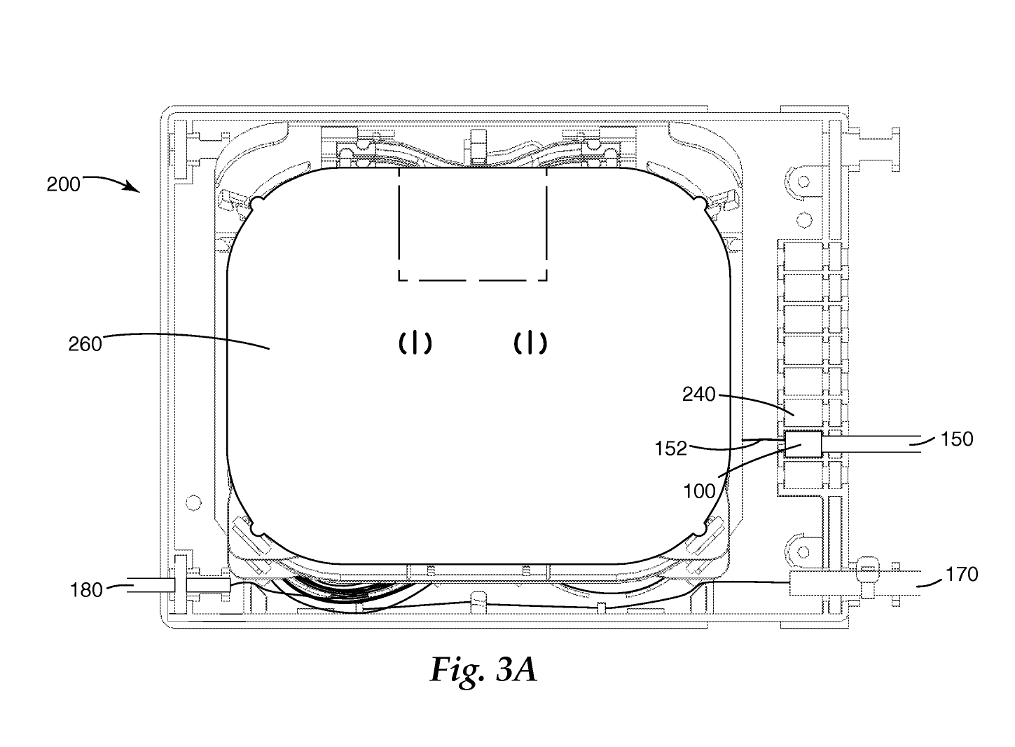

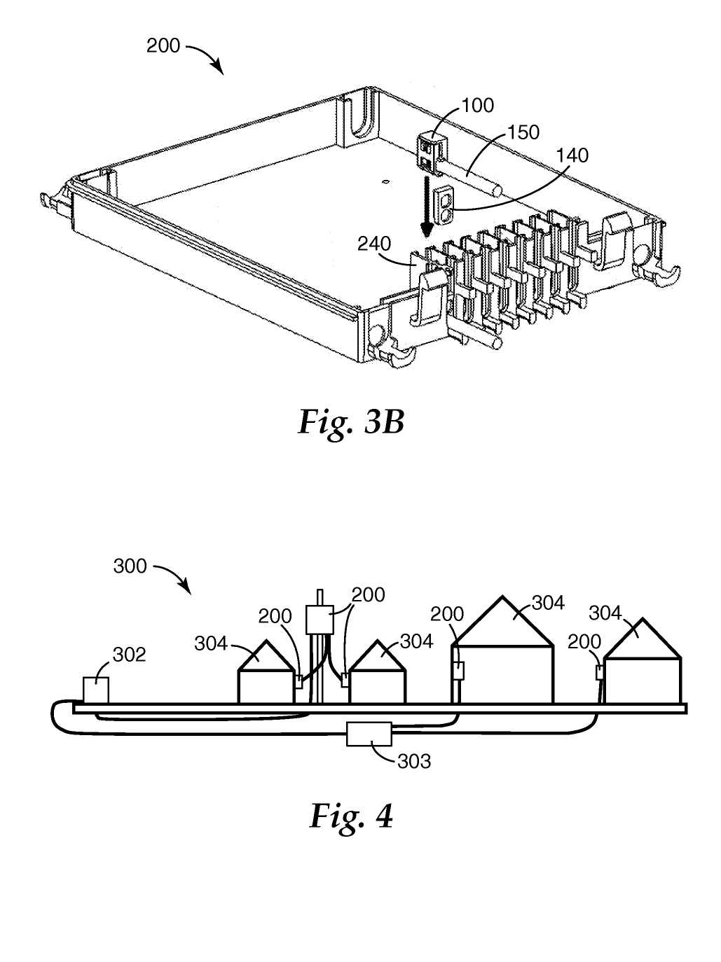

FIGS. 1A and 1B show an optical fiber cable retention device 100 in an open position. Cable retention device 100 is configured to clamp onto the jacket portion of an optical fiber cable 150 (see e.g., FIGS. 2A-2D) and also secure the strength members of the optical fiber cable. The optical fiber cable retention device 100 is configured to be removably securably mountable in a conventional optical communication enclosure, such as a distribution box, fiber drop box 200 (see e.g., FIGS. 3A and 3B), junction box, remote terminal, fiber Network Interface Device (NID), or Optical Network Terminal (ONT) located at a branch point in an optical network (see e.g., FIG. 4).

As shown in FIGS. 1A and 1B, an optical fiber cable retention device 100 can be configured as a single-piece body having first and second opposing body portions 102 and 104 that can engage each other when closed about a hinge portion 106. FIGS. 1A and 1B show optical fiber cable retention device 100 in an open position. Body portions 102 and 104 can be formed from a metal or polymeric material by methods such as injection molding, extrusion, casting, machining, and the like. In a preferred aspect, retention device 100 comprises a molded plastic piece. Hinge 106 can be a conventional hinge shape, preferably an accordion hinge that provides some size flexibility to accommodate more than one size of optical fiber cable.

Body portions 102 and 104 include flexible wall portions 112 and 114, respectively, which are configured to secure the outer jacket 158 of an optical fiber cable via a friction fit. The flexible wall portions 112 and 114 can be configured, for example, as having spring arms which can flex to provide retention force to different sized and different shaped (e.g., round, flat) optical fiber cables. In addition, the surfaces of flexible wall portions 112 and 114 that engage the optical fiber cable can further include small projections or teeth (not shown) to help dig into at least a portion of the outer jacket material of the optical fiber cable being secured. In a preferred aspect, the device is configured to secure the outer jacket of a conventional optical fiber cable. For example, the retention device can be sized to engage a standard optical fiber outer jacket, such as an outer jacket for a conventional 900 μm buffer sleeve or a 250 μm buffer sleeve fiber. Of course, these dimensions are illustrative only of one embodiment, as the dimensional aspects of the retention device can be modified to accommodate different sizes of conventional fiber cables without departing from the scope of the invention, as would be apparent to one of skill in the art given the present description.

Body portions 102 and 104 further include strength member retention areas 122 and 124, respectively. In a preferred aspect, strength member retention areas 122 and 124 are configured to include protrusions 122A, 124A, and 124B, which provide one or more structures about which strength members of the optical fiber cable can be folded or wrapped about (see e.g., FIGS. 2A-2D). In addition, protrusion 122A is configured to be engaged between structures 124A and 124B to reduce side to side movement of body portions 102 and 104 with respect to each other when placed in a closed position.

In addition, body portions 102 and 104 further include a latching mechanism to secure retention device 100 in a closed position. For example, in a preferred aspect, body portion 104 includes a protrusion or clip 134 which engages with an indention 132 formed in body portion 102 that is configured to receive clip 134 in a snap fit. Other latching structures can also be utilized.

In operation, as shown in FIGS. 2A-2D, an optical fiber cable 150 can be secured to a distribution box or fiber drop box using an optical fiber cable retention device 100. Optical Fiber cable 150 includes an outer jacket 158, a strength member or members 157 (e.g., aramide, metallic, or other fiber members or strands) and an inner protective jacket, buffer tube, or coating 155 that surrounds the optical fiber 152.

First, a portion of the outer jacket 158 can be stripped from the fiber cable 150, exposing strength members(s) 157 and inner protective jacket or coating 155. As shown in FIG. 2A (in open view), a user can position the outer jacket 158 in a flexible wall portion of the retention device 100, such as flexible wall portion 114 shown in FIG. 1A. The strength members 157 can then be wrapped in one or more patterns (see FIGS. 2A and 2B) about the projection structures 124A, 124B of the retention area of the retention device 100, such as retention area 124 shown in FIG. 1A. Next, as shown in FIG. 2C, the other body portion of the retention device 100, such as body portion 102 shown in FIG. 1A, can be folded about the device hinge, such as hinge 106 shown in FIG. 1A. The body portions can be latched together via a simple hand force, without the need for a separate clamping tool. FIG. 2D shows the optical fiber cable retention device 100 as a closed structure securing the strength members 157 and outer jacket 158 of fiber cable 150. An excess length of the strength members extending from retention device 100 (see FIG. 2D) can be trimmed off after the device is closed.

As mentioned above, the optical fiber cable retention device 100 is configured to be compact in size and removably securably mountable in a conventional optical communication enclosure, such as a distribution box, fiber drop box, junction box, remote terminal, NID, or ONT. An exemplary enclosure, fiber drop box 200, is shown in FIG. 3A in a top view in an opened state (the cover has been removed for simplicity).

Fiber drop box 200 is a telecommunications enclosure that is used to house one or more connections of fiber at, for example, a branch point of a telecommunications network. In this aspect, fiber box 200 receives a distribution cable 170 from the network. The distribution cable includes one or more optical fibers. Box 200 houses one or more splices or other connections that link the distribution fibers to other floors in the premise (e.g., to a rise cable 180) and/or to a specific customer or home (e.g., to a optical fiber cable 150).

Fiber drop box 200 can include one or more conventional splice trays 260. These splice trays are configured to house one or more fiber splices or connections. The trays 260 can be configured in a conventional manner, such as described in pending PCT Application No. US2007/078391, filed Sep. 13, 2007, incorporated by reference herein in its entirety. Alternatively, fiber drop box 200 may not include a splice tray, but rather any fiber coupling or fiber connection device, such as shown in, e.g., US Publication No. 2006/0067637.

Fiber box 200 can further include one or more cable retention structures 240. In a preferred aspect, the cable retention structures 240 include a series of slots, with each slot sized appropriately to slidably receive and snugly hold an optical fiber cable retention device 100. In a preferred aspect (see e.g., FIGS. 3A and 3B), slots 240 are formed near an outer wall of the fiber box 200 for easier access to entering/exiting fiber cables. The slots can be formed with a series of structures to prevent side-to-side and axial movement of the optical fiber cable retention device. A user can complete the securing sequence described above. In addition, the user can employ a conventional splicing (e.g., mechanical or fusion) or connecting technique to link optical fiber 152 of the optical fiber cable 150 to a distribution fiber. The user can then slide the optical fiber cable retention device 100 into one of the slots 240 to secure the fiber cable 150. In a preferred aspect, retention device 100 can be very compact. For example, retention device 100 can be configured as a structure that is about 10 mm×15 mm×7 mm. Of course, these dimensions represent just one example, as device 100 can be configured to have a different size.

Alternatively, as shown in FIG. 3B, the retention device 100 can also include a cover 140. Cover 140 can be implemented as a gasket (to increase protection against water ingress) and/or spacer portion to provide a more snug fit in slot 240. Additionally, the fiber distribution box 200 may further contain optical splitters (not shown) which can split the signal to drop to multiple subscribers.

In this manner, a user is not required to, e.g., screw down cable strength members to a surface of the fiber box 200, in order to secure a drop (or other) cable from axial pulls or strains. As described above, the optical fiber cable retention device 100 can be used as a small, simple, one-piece securing mechanism that is easily installed to an enclosure, such as fiber box 200.

Fiber box 200 can take any standard shape, such as a standard outside plant closure, and/or it can be implemented in a cabinet environment. The various components and elements of the enclosure 200 can be formed of any suitable material. The materials are selected depending upon the intended application and may include both polymers and metals. Material selection will depend upon factors including, but not limited to, chemical exposure conditions, environmental exposure conditions including temperature and humidity conditions, flame-retardancy requirements, material strength, and rigidity, to name a few.

Fiber box 200 can be employed in a number of different network locations, such as is shown in the schematic network 300 shown in FIG. 4. For example, a Fiber-To-The-Premises (FTTP) Passive Optical Network (PON) architecture is designed to deliver an optical signal between an Optical Line Terminal (OLT) 302 typically located in a Central Office (CO), and an Optical Network Terminal (ONT), often located at or near a customer premise, such as locations 304. The OLT also sends optical signals to remote terminal unit(s) 303. The OLT typically houses laser transmitters dedicated to each user in a point-to-point (PTP) network or shared across several users in a PON. The optical fiber cables carry the signal to the user and is divided into several types: e.g., feeder cable from the central office to the OLT, distribution cable (fanning out across the access network and connected to the feeder cable in the OLT), and drop cables which are connected to the distribution cables in a remote terminal and run to the ONT (used to physically connect the users to the FTTP network) or optical fiber transition box or fiber branch point box. As shown schematically in FIG. 4, fiber branch point boxes 200 including the cable retention devices described herein can be located indoors or outdoors, at individual homes or at multi-person buildings. Also, aerial terminals and enclosures can include the cable retention devices described herein.

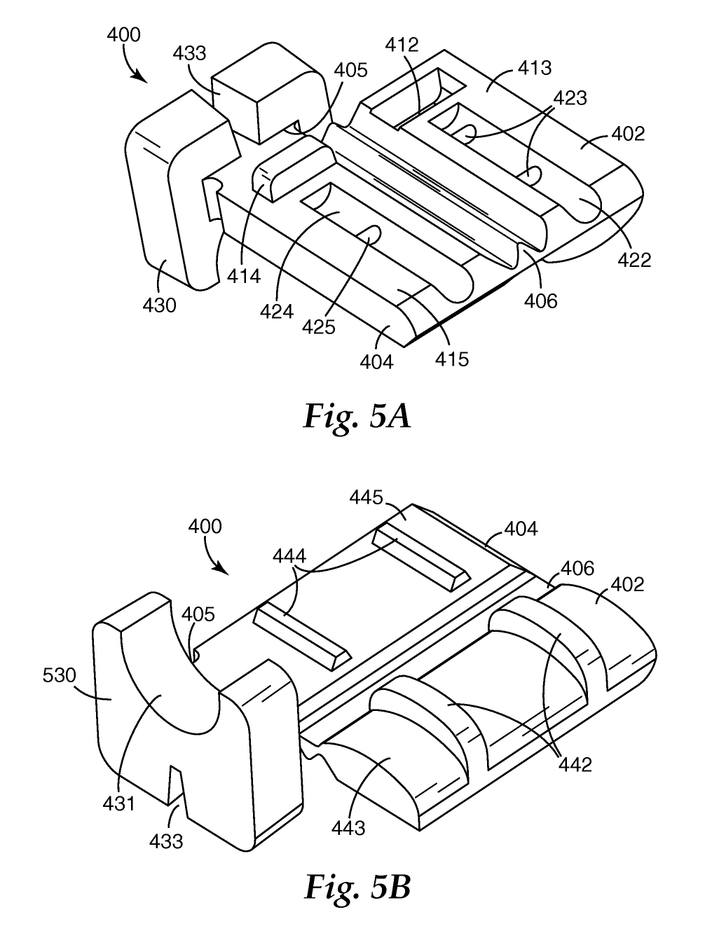

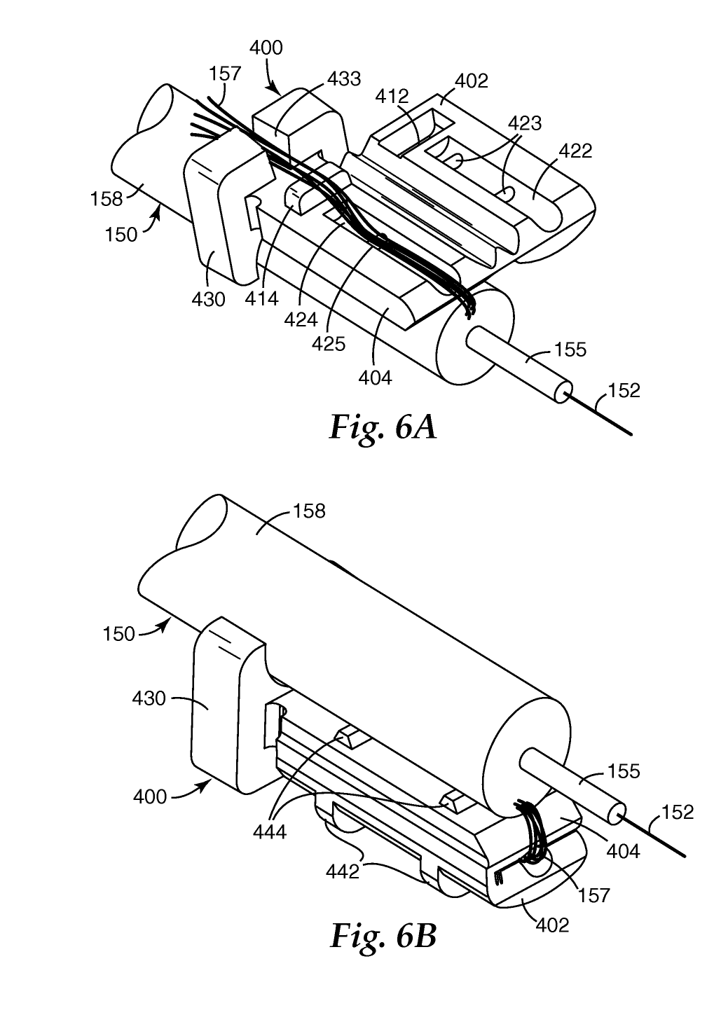

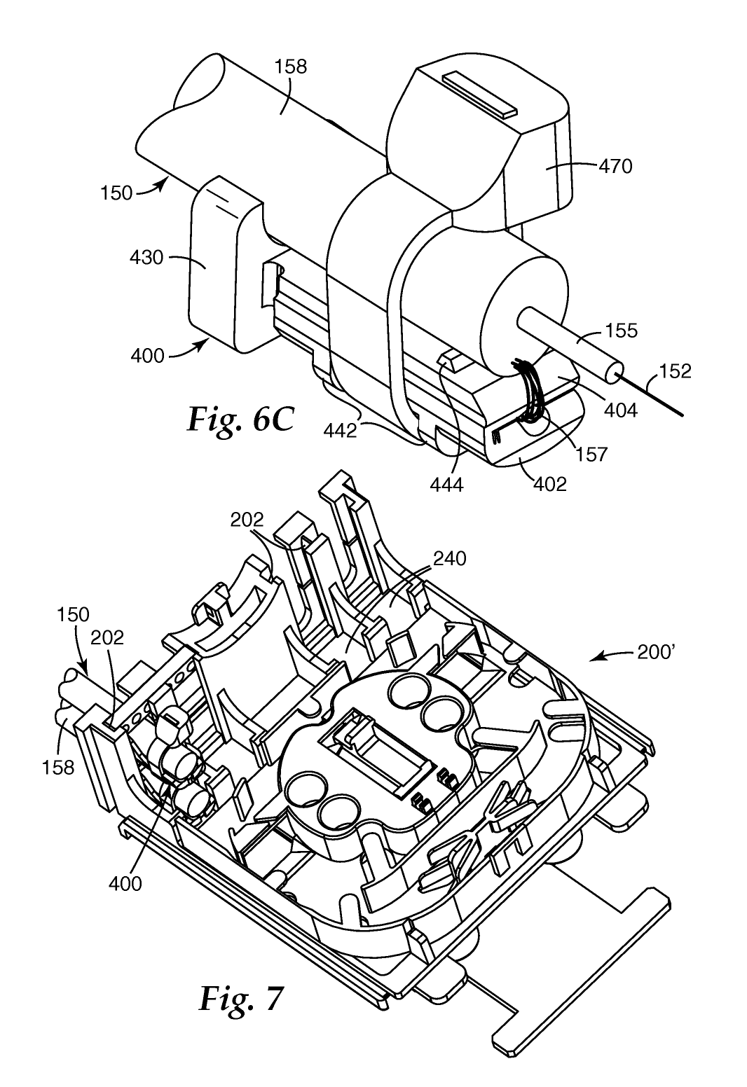

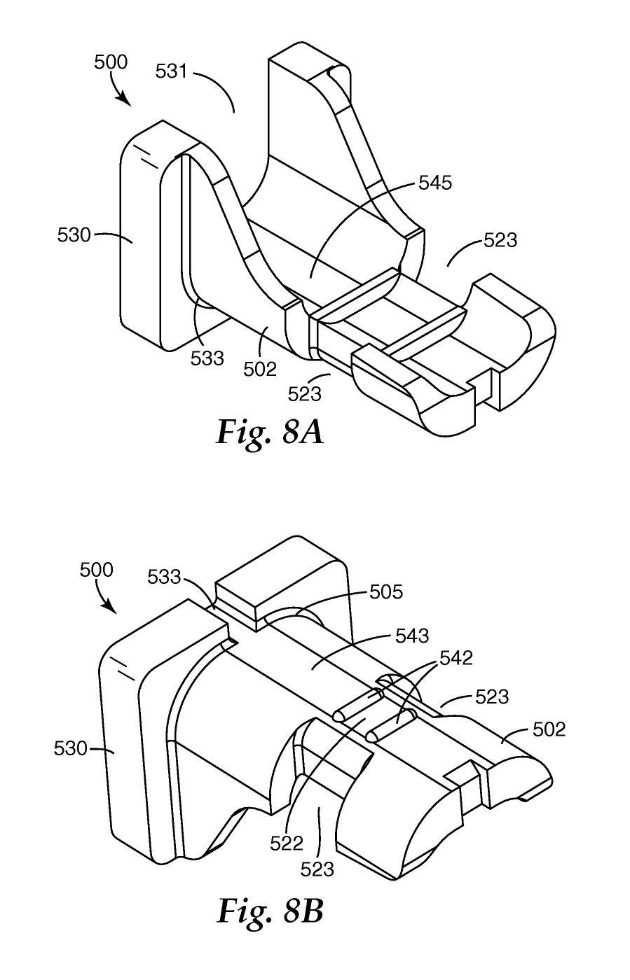

FIGS. 5A and 5B show an alternative embodiment of an optical fiber cable retention device 400 in an open position. Cable retention device 400 may be secured to an optical fiber cable 150 (see FIGS. 6A-6C) while clamping onto the strength members 157 of the optical fiber cable. The retention device 400 is configured to be removably and securably mountable in a conventional optical communication enclosure, such as a distribution box, fiber drop box 200′ (see e.g. FIG. 7), junction box, remote terminal, fiber Network Interface Device (NID), or Optical Network Terminal (ONT) located at a branch point in an optical network (see e.g. FIG. 4).

As shown in FIGS. 5A and 5B, an optical fiber cable retention device 400 may be configured as a single-piece body having first and second opposing body portions 402, 404 that engage each other when closed about a hinge portion 406. The optical fiber cable retention device 400 may also have a base 430 attached to a terminal end 405 of the second body portion 404. Body portions 402 and 404 may be formed from a metal or polymeric material by methods such as injection molding, extrusion, casting, machining, and the like. In a preferred aspect, retention device 400 comprises a molded plastic piece. Hinge 406 may be a conventional hinge shape.

Body portions 402 and 404 may include alignment features on the interior surfaces 413 and 415 of body portions 402, 404, respectively, such as cavity 412 and projection 414 which fits into the cavity 412 when the fiber retention device is closed. These alignment features reduce side to side movement of body portions 402 and 404 with respect to each other when the fiber retention is placed in a closed position. The alignment features may be configured to allow the strength members to be clamped between projection 414 and cavity 412 when the device is closed. Body portions 402 and 404 further include strength member retention areas 422 and 424, respectively. Each of the strength member retention areas may be in the form of a channel formed in the interior surfaces 413, 415 of body portions 402, 404 to accommodate and secure the strength members of the optical fiber cable attached to retention device 400. A plurality of ridges 423, 425 may be added in the channels 422, 424 to facilitate clamping to the strength members of the cable. In a preferred embodiment, the ridges 423, 425 disposed in the channels may be staggered along the length of the channel. In some variations of this embodiment, body portions 402 and 404 further include a latching mechanism (not shown) to secure retention device 400 in a closed position.

Body portions 402 and 404 may include a plurality of ribs 442, 444 formed on the outer surface 443, 445 of the body portions to assist in positioning a cable securing device 470 and prevent the securing device such as a cable tie (see FIG. 6C) from slipping. The securing device 470 secures the optical fiber cable 150 to retention device 400 and traps the strength members of the optical fiber between the body portions of the retention device.

Base 430 may have a generally rectangular shape having an arcuate indention 431 on one side and a notch 433 disposed on the opposite side of the base from the indentation. The arcuate indention 431 may be sized to accommodate a standard optical fiber outer jacket, such as an outer jacket for a conventional 900 μm buffer sleeve or a 250 μm buffer sleeve fiber. The notch 433 may be sized to accommodate passage of any residual length of the strength members of the optical cable when the device is mounted on the cable. Base 430 may be attached to the terminal end 405 of body portion 404 by a mechanical device such as an interference fit or by an adhesive. Alternatively, base 430 may be attached to a terminal end of body portion 402 (not shown). Alternatively, base 430 may be formed as an integral portion of retention device 400.

The cable retention device may be mounted on an optical fiber cable as shown in FIGS. 6A-6C. Optical fiber cable 150 includes an outer jacket 158, a strength member or plurality of strength members 157 (e.g., aramide, metallic, or other fiber members or strands) and an inner protective jacket, buffer tube, or coating 155 that surrounds the optical fiber 152. A portion of the outer jacket 158 may be stripped from the fiber cable 150, exposing strength member(s) 157 and inner protective jacket or coating 155. As shown in FIG. 6A (in open view), a user may position the cable such that it lies in the arcuate indention 431 of base 430 and the outer jacket 158 rests against the outer surface 445 of body portion 404 of the retention device 400. The strength members 157 may then be wrapped over the end of body portion 404 and positioned in the retention area of the retention device 400, such as channel 424.

As shown in FIG. 6B, the other body portion of retention device 400, such as body portion 402, may be folded about the device hinge, such as hinge 406, shown in FIG. 5A to trap the strength member(s) between the two body portions. The body portions may be fastened together and the cable secured to the device by placing cable securing device 470 (e.g. a cable tie) around the device as shown in FIG. 6C. Any excess length of the strength members extending from retention device 400 may be trimmed after the device is closed and secured to the optical fiber cable.

As mentioned above, the optical fiber cable retention device 400 is configured to be compact in size and removably securably mountable in a conventional optical communication enclosure, such as a distribution box, fiber drop box, junction box, remote terminal, NID, or ONT. FIG. 7 shows an optical fiber cable 150 secured to a distribution box or fiber drop box 200′, using an optical fiber cable retention device 400 (see FIGS. 6A-6C). Base 430 may be configured to fit into grooves 202 in fiber drop box 200′. Fiber drop box 200′ may have similar features as described previously with relation to box 200 shown in FIGS. 3A and 3B.

Fiber box 200′ may include one or more cable retention structures 240. In a preferred aspect, the cable retention structures 240 include a series of slots, with each slot sized appropriately to slidably receive and snugly hold an optical fiber cable retention device 400. In an aspect (see FIGS. 3A and 7), slots 240 can be formed near an outer wall of the fiber box 200, 200′ for easier access to entering/exiting fiber cables and may include a plurality of grooves to receive and engage with the base 430 of retention device 400. The slots may be formed with a series of structures to prevent side-to-side and axial movement of the optical fiber cable retention device.

Prior to installation of the retention device into the drop box, the user may employ a conventional splicing (e.g., mechanical or fusion) or connecting technique to link the fiber of the drop cable to a distribution fiber. The user may then slide the optical fiber cable retention device 400 into one of the slots 240 to secure the fiber cable 150. In a preferred aspect, retention device 400 may be very compact. For example, retention device 400 may be configured as a structure that is about 10 mm×15 mm×7 mm. Of course, these dimensions represent just one example, as retention device 400 may be configured to have a different size. Of course, these dimensions are illustrative only of one embodiment, as the dimensional aspects of the retention device may be modified to accommodate different sizes of conventional fiber cables without departing from the scope of the invention, as would be apparent to one of skill in the art given the present description.

In this manner, a user is not required to, e.g., screw down cable strength members to a surface of the fiber box 200′, in order to secure a drop (or other) cable from axial pulls or strains. As described above, the optical fiber cable retention device 400 may be used as a small, simple, one-piece securing mechanism that is easily installed to a enclosure, such as fiber box 200′.

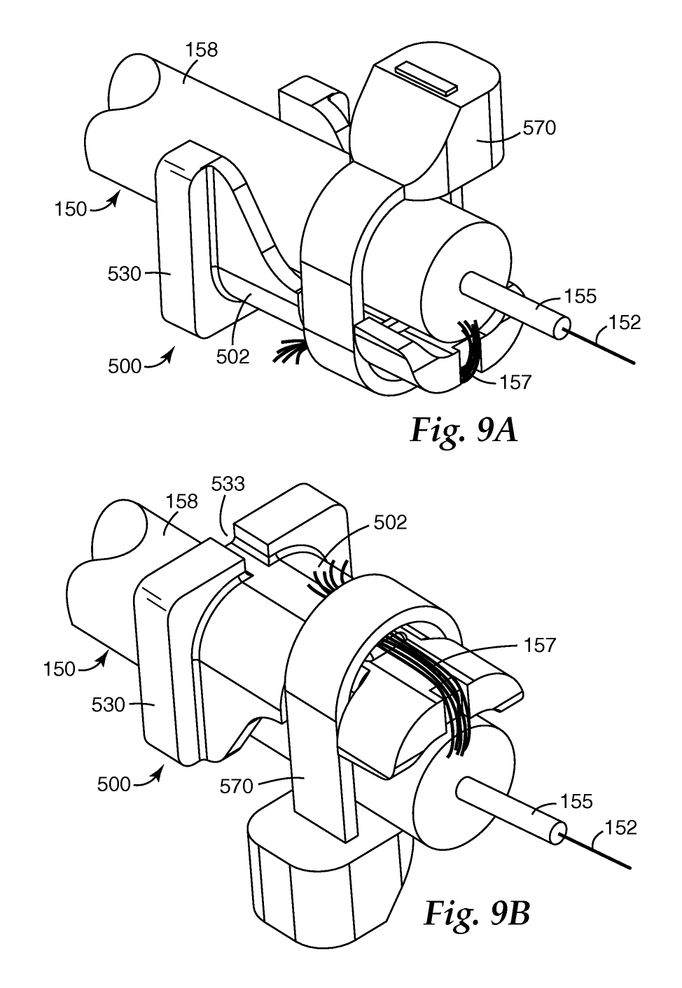

FIGS. 8A and 8B show another alternative embodiment of an optical fiber cable retention device 500. Cable retention device 500 is configured to be secured to an optical fiber cable (see e.g., FIGS. 9A-9B) while also securing the strength members of the optical fiber cable. The optical fiber cable retention device 500 is configured to be removably and securably mountable in a conventional optical communication enclosure, such as a distribution box, fiber drop box, junction box, remote terminal, fiber Network Interface Device (NID), or Optical Network Terminal (ONT) located at a branch point in an optical network (FIG. 4).

As shown in FIGS. 8A and 8B, an optical fiber cable retention device 500 may be configured as a single-piece body having a body portion 502 and a base 530 attached to one terminal end 505 of body portion 502. Body portions 502 and base 530 may be formed from a metal or polymeric material by methods such as injection molding, extrusion, casting, machining, and the like. In a preferred aspect, retention device 500 may be a molded plastic piece.

Body portion 502 may include a concave top surface 545 to cradle an optical fiber cable when it is installed in the retention device. Body portion 502 may include a strength member retention area 522 on the bottom surface 543 of body portion 502. The strength member retention area may include a plurality of ribs 542 on the bottom surface 543 of the body portion to position a cable securing device 570 such as a cable tie (see FIGS. 9A and 9B) which secures the optical fiber cable 150 and the strength members to retention device 500. In addition, body portion 502 may have at least one notch adjacent to the strength member retention area 522 to accommodate the cable securing device and provide for better connection of the cable securing device to the optical fiber cable and the retention device.

Base 530 may have a generally rectangular shape having an arcuate indention 531 on one side and a notch 533 disposed on the opposite side of the base from indentation 531. The arcuate indention 531 may be sized to accommodate a standard optical fiber outer jacket, such as an outer jacket for a conventional 900 μm buffer sleeve or a 250 μm buffer sleeve fiber. The notch 533 may be sized to accommodate passage of any residual length of the strength members 157 of the optical cable when the device is mounted on the fiber cable 150. Base 530 may be attached to the terminal end 505 of body portion 502 by a mechanical device such as an interference fit or by an adhesive. Alternatively, base 530 may be formed as an integral portion of retention device 500.

FIGS. 9A and 9B show two views of an optical fiber cable 150 installed in cable retention device 500. To install the cable into the retention device 500, a portion of the outer jacket 158 may be stripped from the fiber cable 150, exposing strength members(s) 157 and inner protective jacket or coating 155. A user may position the cable such that it lies in the arcuate indentation 531 of base 530 and the outer jacket 158 rests against the top surface 545 of body portion 502 of the retention device 500. The strength members 157 may then be wrapped over the end of body portion 502 and positioned in the retention area of the retention device 500, such as retention area 524 shown in FIG. 8B. A cable securing device is fitted over the retention device 500 in notches 523 and tightened to secure both the optical fiber cable 150 and the strength members 157 to retention device 500. Any excess length of the strength members extending from retention device 500 may be trimmed off after the securing device is tightened in place.

As mentioned above, the optical fiber cable retention device 500 is configured to be compact in size and removably securably mountable in a conventional optical communication enclosure, such as a distribution box, fiber drop box, junction box, remote terminal, NID, or ONT as previously described with respect to retention device 400.

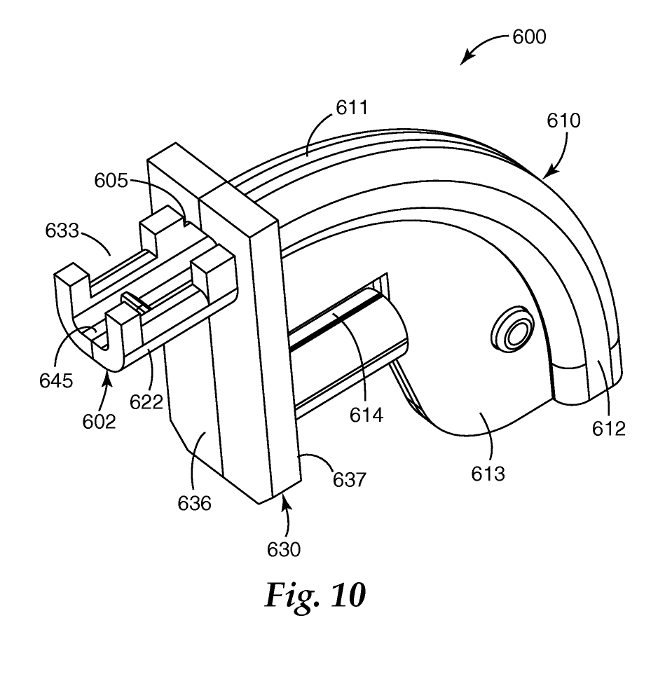

FIG. 10 shows another alternative embodiment of an optical fiber cable retention device 600. Cable retention device 600 is configured to be secured to an optical fiber cable while also securing the strength members of the optical fiber cable and providing minimum bend radius control of the optical fiber cable. The optical fiber cable retention device 600 is configured to be removably and securably mountable in a conventional optical communication enclosure, such as a distribution box, fiber drop box, junction box, remote terminal, fiber Network Interface Device (NID), or Optical Network Terminal (ONT) located at a branch point in an optical network (FIG. 4).

As shown in FIG. 10, an optical fiber cable retention device 600 may be configured as a single-piece body having a base 630, a body portion 602 attached to a first face 636 of the base 630 and an arcuate guide portion 610 attached to a second face 637 of the base 630 wherein the second face 637 of the base is opposite the first face 636 of the base. The retention device 600 may be formed from a metal or polymeric material by methods such as injection molding, extrusion, casting, machining, and the like. In a preferred aspect, retention device 600 may be a molded plastic piece.

Body portion 602 may include a concave top surface 645 to cradle an optical fiber cable when it is installed in retention device 600. Body portion 602 may include a strength member retention area 622 on the bottom surface 643 of body portion 602. The strength member retention area 622 may include a plurality of ribs on the bottom surface 643 of the body portion to position a cable securing device such as a cable tie (as described with respect to FIGS. 8A, B and 9A, B) which secures the optical fiber cable and the strength members to retention device 600. In addition, body portion 602 may have at least one notch adjacent to the strength member retention area 622 to accommodate the cable securing device and provide for better connection of the cable securing device to the optical fiber cable and the retention device.

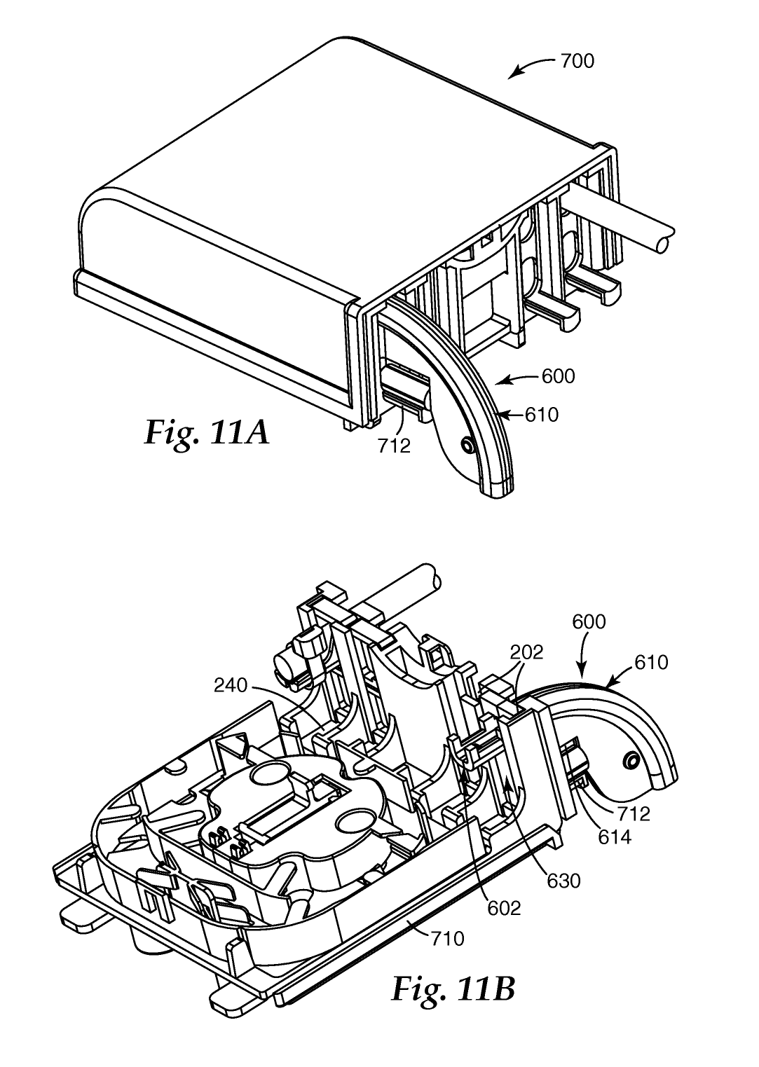

Arcuate guide portion 610 may be attached to the second face 637 of base 630. The arcuate guide portion 610 includes a guide 612 to maintain a desired bend radius of an optical fiber cable in the retention device 600 and a reinforcing section 613 to support the guide 612. In an exemplary embodiment, the guide 612 may be a closed tube integrally formed in the arcuate guide portion 610 at the outer radial edge 611 of the arcuate guide portion. Alternatively, the guide 612 may be a u-shaped channel formed in the outer radial edge 611 of the arcuate guide portion. Optionally, a slot 614 may be formed in the reinforcing section 613 to secure the arcuate guide portion to an external support 712 by a cable tie for example on a fiber box 700 (see FIGS. 11A and 11B).

Base 630 may have a generally rectangular shape having an indention or passage (not shown) through the base and aligned with the concave top surface 645 of body portion 602 and with one end of the guide 612 of the arcuate guide portion 610. Thus, the optical fiber cable may be supported through the retention device 600. The arcuate indention may be sized to accommodate a standard optical fiber outer jacket, such as an outer jacket for a conventional 900 μm buffer sleeve or a 250 μm buffer sleeve fiber. Base 630 may be attached to the terminal end 605 of body portion 602 by a mechanical device, by an interference fit or by an adhesive on a first face 636 of the base. Similarly, base 630 may be attached to an end of arcuate guide portion 610 by a mechanical device, by an interference fit, or by an adhesive on a second face 637 of the base. Alternatively, the body portion, the base and the arcuate guide portion may be formed as a single, integral retention device.

As mentioned above, the optical fiber cable retention device 600 is configured to be compact in size and removably securably mountable in a conventional optical communication enclosure, such as a distribution box, fiber drop box, junction box, remote terminal, NID, or ONT. FIGS. 11A and 11B show an optical fiber cable retention device 600 installed in a fiber box 700. Fiber box 700 may include a bottom 710 and a cover which can be attached to the bottom to close the fiber box. In one embodiment the cover may be hingedly attached to the bottom. Base 630 of retention device 600 may be configured to fit into grooves 202 in fiber drop box 700. When retention device 600 is installed into fiber box 700, the body portion 602 will be located inside the fiber box while the arcuate guide portion 610 is located outside of the fiber box. Fiber box 700 may have similar features as described previously with relation to box 200 shown in FIGS. 3A and 3B.

Fiber box 700 may include one or more cable retention structures 240. In a preferred aspect, the cable retention structures 240 include a series of slots, with each slot sized appropriately to slidably receive and snugly hold an optical fiber cable retention device 600. The cable retention structures 240 can be formed near an outer wall of the fiber box 700 for easier access to entering/exiting fiber cables and may include a plurality of grooves 202 to receive and engage with the base 630 of retention device 600. The cable retention structures 240 prevent side-to-side and axial movement of the optical fiber cable retention device.

If retention device 600 has a guide tube, the fiber optic cable is slipped through the tube prior connecting the drop cable to a distribution fiber by conventional splicing (e.g., mechanical or fusion) or other connecting technique. Once the connection is complete the user may position retention device 600 and secure it to the fiber cable. Retention device 600 may then be inserted into one of the cable retention structures 240 to complete the installation of the retention device into fiber box 700. Advantageously, retention device 600 eliminates the need to secure the cable strength members to a surface of the fiber box 700 in order to secure a drop (or other) cable from axial pulls or strains. Also, the arcuate guide portion 610 ensures that the minimum bed radius of the fiber cable is not violated. As described above, the optical fiber cable retention device 600 may be used as a small, simple, one-piece securing mechanism that is easily installed to an enclosure, such as fiber box 700.

Advantageously, some embodiments of the cable retention devices described herein can be fully contained within the distribution box improving the overall aesthetics of the box and eliminating external projections which may catch on other cables or clothing, thus reducing the chance of damaging the box or the optical connection made inside of the box. Another advantage of the retention devices described herein is that they may be attached to the optical fiber cable prior to making the optical connection (e.g. optical splice), thereby reducing the chance of interfering with the connection by excessive handling of the cable after the splice has been made.

Although specific embodiments have been illustrated and described herein for purposes of description of the preferred embodiment, it will be appreciated by those of ordinary skill in the art that a wide variety of alternate or equivalent implementations may be substituted for the specific embodiments shown and described without departing from the scope of the present invention. Those with skill in the art will readily appreciate that the present invention may be implemented in a very wide variety of embodiments. This application is intended to cover any adaptations or variations of the embodiments discussed herein.

We claim:

1. An optical fiber cable retention device, comprising:
a body having first and second opposing body portions; and
a hinge disposed therebetween to retain an optical fiber cable when the optical fiber cable retention device is placed in a closed position, wherein the first and second body portions are engageable with one another about the hinge and wherein at least one of the first and second body portions includes a strength member retention area having one or more structures configured to engage a strength member of the optical fiber cable.

2. The retention device of claim 1, wherein at least one of the first and second body portions comprises a flexible wall portion configured to provide a retention force to an outer jacket of the optical fiber cable.

3. The retention device of claim 2, wherein the flexible wall portion includes flexible spring arms to provide retention force to different sized and different shaped optical fiber cables.

4. The retention device of claim 2, wherein the flexible wall portion comprises teeth to engage and dig into the outer jacket material of the optical fiber cable.

5. The retention device of claim 1, further comprising a latching mechanism to secure the retention device in the closed position.

6. The retention device of claim 1, further comprising a first protrusion formed on the first body portion and a second protrusion and a third protrusions formed on the second body portion, wherein the strength members of the optical fiber cable are wound around the second protrusion and the third protrusion and wherein the first protrusion is engageable between the second and third protrusions when the device is in the closed position to secure the strength members in the retention device.

7. The retention device of claim 1, further comprising a base attached to a terminal end of the second body portion.

8. The retention device of claim 7, wherein the base comprises an arcuate indentation to accommodate the optical fiber cable as it passes through the base.

9. The retention device of claim 1, further comprising a securing device to secure the optical fiber to the retention device.

10. The retention device of claim 9, further comprising a plurality of ribs formed on the outer surface of at least one of the first and second body portions to position the securing device.

11. A fiber distribution box disposable at a branch point of an optical fiber network, comprising:
a base,
a cover that is engageable with the base; and
a plurality of optical fiber cable retention devices according to claim 1.

12. The distribution box of claim 11, further comprising a splice tray attached to the base of the distribution box.

13. An optical fiber cable retention device, comprising:
a body portion having a concave surface; and
a base attached to the terminal end of the body portion;
wherein the base includes an arcuate indentation aligned with the concave surface of the body portion to accommodate an optical fiber cable disposed thereon, wherein the body portion include a strength member retention area disposed on a side opposite the concave surface, and wherein the retention area comprises one or more structures configured to engage strength members of the optical fiber cable when a securing device is engaged with the body portion.

14. A fiber distribution box disposable at a branch point of an optical fiber network, comprising:
a base,
a cover that is engageable with the base; and
a plurality of optical fiber cable retention devices according to claim 13.

15. The distribution box of claim 14, further comprising a splice tray attached to the base of the distribution box.

16. The retention device of claim 7, wherein the base includes a first face and a second face opposite the first face and wherein the second body portion is attached to the first face of the base.

17. The retention device of claim 16, further comprising an arcuate guide portion attached to a second face of the base.

18. The retention device of claim 13, wherein the base includes a first face and a second face opposite the first face and wherein the body portion is attached to the first face of the base.

19. The retention device of claim 18, further comprising an arcuate guide portion attached to a second face of the base.
